(19) United States
(12) Patent Application Publication
(10) Pub. No.: US 2002/0039230 A1
(43) Pub. Date: Apr. 4, 2002

(54) 3D image display system

(75) Inventor: Ming-Yen Lin, Taipei (TW)

Correspondence Address: DOUGHERTY & TROXELL, 5205 LEESBURG PIKE, SUITE 1404, FALLS CHURCH, VA, 22041, US

(73) Assignee: ARTIFICIAL PARALLAX ELECTRONICS CORP.

(21) Appl. No.: 09/729,819

(22) Filed: Dec. 6, 2000

(30) Foreign Application Priority Data
Sep. 29, 2000 (TW) 89120187

(51) Int. Cl. G02F 1/1335; G02B 27/22

(52) U.S. Cl. 359/465; 359/464; 349/15

(57) ABSTRACT

A 3D image display system comprising an image display, an image polarizing processor, an image filter, an image synchronizer, and a pair of electronic liquid crystal polarizing spectacles is capable of presenting a 3D image in combination with the conventional low-frequency Field-Sequential Displaying technique. To begin with, by utilizing an optical polarizing process, the possible region where the flickering phenomenon may occur is confined on the screen of the display such that the region may become a small portion of the visual space. Next, an image filter is used to reduce to the intensity of the localized flickering region. Therefore, the flickering phenomenon can be effectively reduced even at a low scanning frequency of 60 Hz.

### AMBIENT OF THE INVENTION

1. Field of the Invention

The present invention relates to a 3D image display system, more particularly to a 3D image display system provided to reduce the flickering phenomenon in the entire visual space caused by the conventional electronic liquid crystal shutter spectacles operating at a low scanning frequency. According to the present invention, a 3D image display system comprising an image display, an image polarizing processor, an image filter, an image synchronizer, and a pair of electronic liquid crystal polarizing spectacles is capable of presenting a 3D image in combination with the conventional low-frequency Field-Sequential Displaying technique. To begin with, by utilizing an optical polarizing process, the possible region where the flickering phenomenon may occur is confined on the screen of the display such that the region may become a small portion of the visual space. Later, an image filter is used to reduce to the intensity of the localized flickering region. Therefore, the flickering phenomenon can be effectively reduced even at a low scanning frequency of 60 Hz.

2. Description of the Prior Art

The so-called “flickering phenomenon” occurs when using 3D electronic liquid crystal shutter spectacles to view a 3D image presented by the conventional television. The cause of the flickering phenomenon is described hereinafter. The electronic liquid crystal shutters on the 3D spectacles basically perform an optical shielding and penetrating process in the entire visual space of the viewer. When the scanning frequency of 3D image is not sufficiently high, in addition to the screen of the display, the ambient light also leads to intensive flickering due to the low-frequency shielding and penetrating process of the electronic liquid crystal shutters.

Please refer to FIG. 1, which is a schematic diagram showing the flickering phenomenon when the conventional 3D electronic liquid crystal shutter spectacles operate at a low frequency. In general, according to the conventional low-frequency Field-Sequential Displaying technique, when a 3D image is viewed by a pair of 3D electronic liquid crystal shutter spectacles, the left 3D image L and the right 3D image R are alternatively scanned onto the screen 9 of a display, and the left electronic liquid crystal shutter 2 and the right electronic liquid crystal shutter 3 are alternatively switched. However, the electronic liquid crystal shutter performs its optical shielding and penetrating function upon the screen 9 of the display and the ambient light outside the screen. In other words, when the left 3D image L is scanned on the screen 9 of the display, the left electronic liquid crystal shutter 2 is set to be transparent while the right electronic liquid crystal shutter 3 is set to be opaque. Therefore, the left eye 5 of the viewer can perceive the left 3D image L, the image 11 of the display, and the left ambient image 10, while the right eye 6 cannot perceive any image 7. On the contrary, when the right 3D image R is scanned on the screen 9 of the display, the right electronic liquid crystal shutter 3 is set to be transparent while the left electronic liquid crystal shutter 2 is set to be opaque. Therefore, the right eye 6 of the viewer can perceive the right 3D image R, the image 15 of the display, and the right ambient image 14, while the left eye 5 cannot perceive any image 7. Accordingly, for a viewer's eyes, not only the light from the screen causes a flickering phenomenon but also the light from the ambient environment causes a more considerable flickering phenomenon at a low image scanning frequency. To sum up, the long-existing 3D electronic liquid crystal shutter spectacles have failed to solve the problems related to the flickering phenomenon such that the device cannot cooperate with the low scanning frequency television so as to provide an enjoyable environment for viewing 3D images.

### SUMMARY OF THE INVENTION

In order to overcome the problems related to the flickering phenomenon of the conventional 3D electronic liquid crystal shutter spectacles, it is the primary object of the present invention to provide a 3D image display system using an optical process characterized in the “localizing the shuttering process in the limited visual space”, wherein the optical process due to shutter switching is confined on the screen of the display such that the optical process is not performed upon the ambient light outside the screen, so as to cooperate with the conventional displays such as a television, a monitor, a liquid crystal monitor, a plasma display panel, and a projector to effectively reduce the flickering phenomenon. Therefore, for a viewer's eyes, only the light from the screen shows the flickering phenomenon while the light from the ambient environment outside the screen does not. And also, the intensity of the flickering image is attenuated such that the flickering phenomenon due to low scanning frequency operation is reduced effectively.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a schematic diagram showing the flickering phenomenon when the conventional 3D electronic liquid crystal shutter spectacles operate at a low frequency;

FIG. 2 is a schematic diagram showing the optical principle of “localizing the shuttering process in the limited visual space” in accordance with the present invention;

FIG. 3 is a schematic block diagram showing a 3D image display system in accordance with the present invention;

FIG. 4A is a schematic diagram showing the optical function when the liquid crystal polarizer is at a shielding state in accordance with the present invention; and

FIG. 4B is a schematic diagram showing the optical function when the liquid crystal polarizer is at a penetrating state in accordance with the present invention.

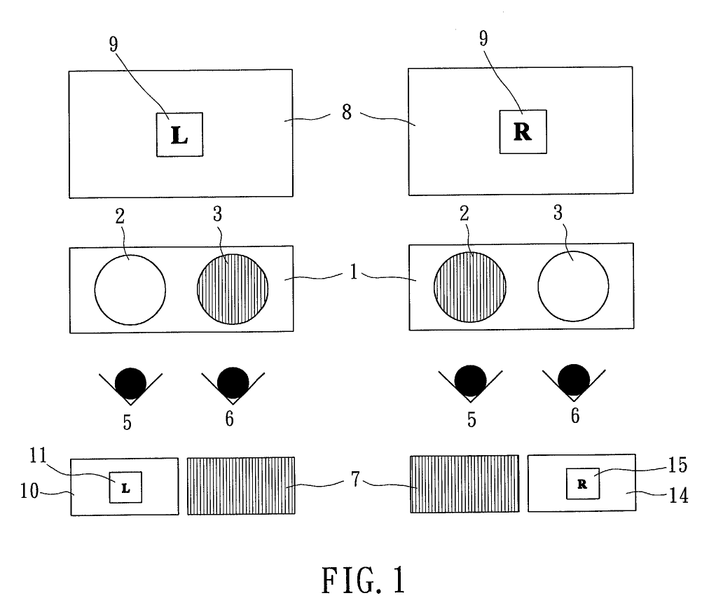

### DETAILED DESCRIPTION OF THE INVENTION

The present invention provides a 3D image display system using an optical principle characterized in the “localizing the shuttering process in the limited visual space”, wherein the 3D image display system comprising an image display, an image polarizing processor, an image filter, an image synchronizer, and a pair of electronic liquid crystal polarizing spectacles, so as to effectively reduce the flickering phenomenon even at a low scanning frequency. The optical principle characterized in the “localizing the shuttering process in the limited visual space” will be described hereinafter by the accompanying drawings and the preferred embodiment.

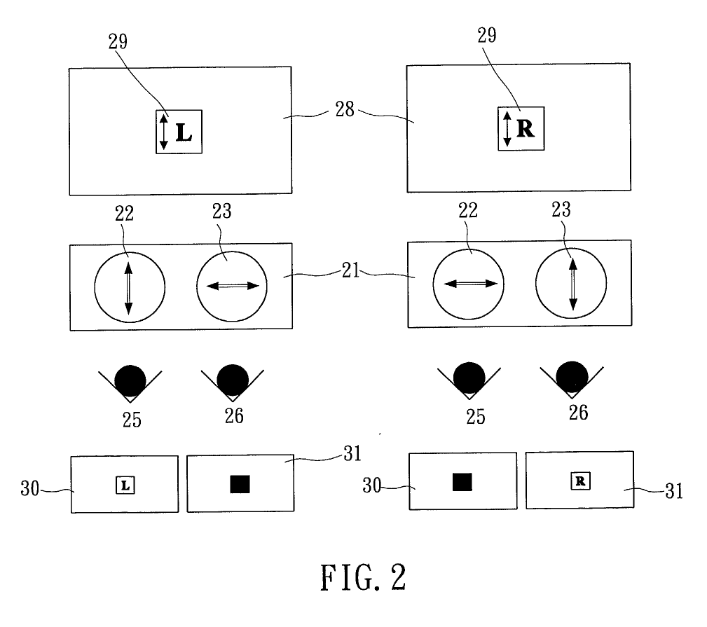

Please refer to FIG. 2, which is a schematic diagram showing the optical principle of “localizing the shuttering process in the limited visual space” in accordance with the present invention. For a simplified case, all the polarized lights are exemplified by linear vertically-polarized lights. In the visual space of a viewer, the light can be divided into the light from the screen 29 and the light from the ambient environment 28 outside the screen. To begin with, the light from the screen 29 is vertically polarized such that both the left 3D image L and the right 3D image R on the screen are vertically polarized. Later, the orientation of the left polarizer 22 and the orientation of the right polarizer 23 on the polarizing spectacles 21 can be alternatively set and synchronized to the image scanning timing such that the shutter switching function is performed only upon the light from the screen 29 but not upon the light from the ambient environment 28 outside the screen. In other words, when the left 3D image L is scanned on the screen 29 of the display, the left 3D image L is vertically polarized such that the left 3D image L and the light from the ambient environment 28 can pass through the left polarizer 22 since the left polarizer 22 is set to be vertically polarized. On the other hand, the light from the ambient environment 28 is also allowed to pass through the right polarizer 23 while the left 3D image L is filtered out since the right polarizer 23 is set to be horizontally polarized. Therefore, the left eye 25 of the viewer can perceive the left 3D image L and the left ambient image 30 while the right eye 26 of the viewer can perceive the right ambient image 31 but not the left 3D image L. On the contrary, when the right 3D image R is scanned on the screen 29 of the display, the right 3D image R is vertically polarized such that the right 3D image R and the light from the ambient environment 28 can pass through the right polarizer 23 since the right polarizer 23 is set to be vertically polarized. On the other hand, the light from the ambient environment 28 is allowed to pass through the left polarizer 22 while the right 3D image R is filtered out since the left polarizer 22 is set to be horizontally polarized. Therefore, the right eye 26 of the viewer can perceive the right 3D image R and the right ambient image 31 while the left eye 25 of the viewer can perceive the left ambient image 30 but not the right 3D image R.

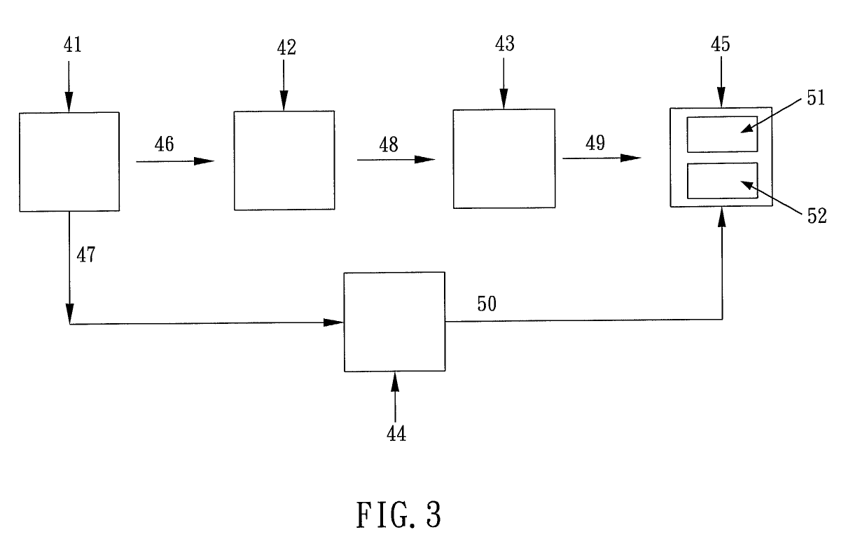

Please further refer to FIG. 3, which is a schematic block diagram showing a 3D image display system in accordance with the present invention. The 3D image display system comprises: an image display 41, an image polarizing processor 42, an image filter 43, an image synchronizer 44, and a pair of electronic liquid crystal polarizing spectacles 45. The image display 41 is used for outputting a 3D image 46 and a scanning synchronous signal 47, wherein the scanning synchronous signal 47 is output through wire or wireless communication. The polarizing processor 42 is used for receiving and polarizing the 3D image 46 so as to output a polarized 3D image 48. The image filter 43 is used for receiving and attenuating the polarized 3D image 48 so as to output a polarized and attenuated image 49. The image synchronizer 44 is used for receiving the scanning synchronous signal 47 and outputting a driving signal 50 for liquid crystal polarizers. The pair of electronic liquid crystal polarizing spectacles 45 having a left liquid crystal polarizer 51 and a right liquid crystal polarizer 52 receive the polarized and attenuated image 49, so as to determine the polarizing states of the left and the right polarizers 51, 52 according to the driving signal 50, respectively, such that the polarized and attenuated image 49 can only pass through the left polarizer 51 or the right polarizer 52.

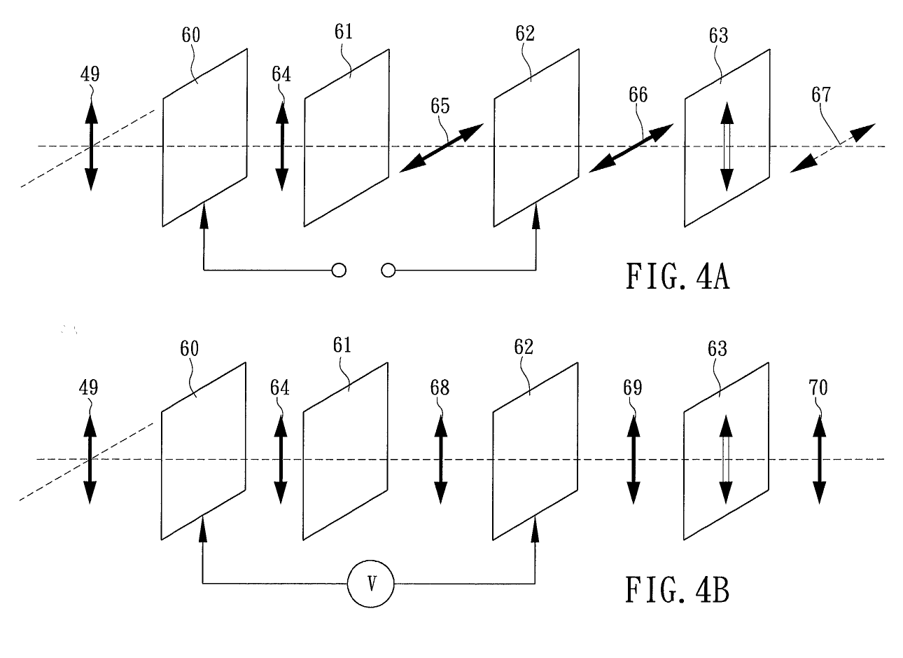

FIG. 4A is a schematic diagram showing the optical function when the liquid crystal polarizer is at a shielding state in accordance with the present invention; and FIG. 4B is a schematic diagram showing the optical function when the liquid crystal polarizer is at a penetrating state in accordance with the present invention. The liquid crystal polarizer comprises: two pieces of transparent conductive glass 60, 62, a liquid crystal molecule layer 61, and a linear polarizing filter 63 with a vertically polarizing axis, wherein the two pieces of transparent conductive glass 60, 62 are used to enclose and protect the liquid crystal molecule layer 61 and can receive an external electric signal. For the polarized and attenuated image 49, the liquid crystal polarizer is determined to be at a shielding state or at a penetrating state depending on the driving signal 50. FIG. 4A shows that the liquid crystal polarizer is at a shielding state when the driving signal 50 is at a zero voltage. In other words, the polarized and attenuated image 49 can pass through the piece of transparent conductive glass 60 to become a vertically polarized image 64. Then, the vertically polarized image 64 becomes a horizontally polarized image 65 after passing through the liquid crystal molecule layer 61 that is not applied with any external voltage. Then, the horizontally polarized image 65 remains a horizontally polarized image 66 after passing through the piece of transparent conductive glass 62. The horizontally polarized image 66 is entirely filterer out by the linear polarizing filter 63 with a vertically polarizing axis. Consequently, the liquid crystal polarizer is at a shielding state 67. On the contrary, FIG. 4B shows that the liquid crystal polarizer is at a penetrating state when the driving signal 50 is not at a zero voltage. In other words, the polarized and attenuated image 49 can pass through the piece of transparent conductive glass 60 to become a vertically polarized image 64. Then, the vertically polarized image 64 remains a vertically polarized image 68 after passing through the liquid crystal molecule layer 61 that is applied with an external voltage. Then, the vertically polarized image 68 remains a vertically polarized image 69 after passing through the piece of transparent conductive glass 62. The vertically polarized image 69 can pass through the linear polarizing filter 63 with a vertically polarizing axis, and remain a vertically polarized image 70.

As discussed so far, in accordance with the present invention, there is provided a 3D image display system provided to effectively reduce the flickering phenomenon in the entire visual space caused by the conventional electronic liquid crystal shutter spectacles operating at a low scanning frequency. Consequently, the present invention has been examined to be progressive and has great potential in commercial applications.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is

1. A 3D image display system, comprising:
an image display for outputting a 3D image and a scanning synchronous signal, wherein said scanning synchronous signal is output through wire or wireless communication;
an image polarizing processor for receiving and polarizing said 3D image so as to output a polarized 3D image;
an image filter for receiving and attenuating said polarized 3D image so as to output a polarized and attenuated image;
an image synchronizer for receiving said scanning synchronous signal and outputting a driving signal for liquid crystal polarizers; and
a pair of electronic liquid crystal polarizing spectacles with a left liquid crystal polarizer and a right liquid crystal polarizer, for receiving said polarized and attenuated image, so as to determine the polarizing states of said left and said right polarizers according to said driving signal, respectively;
wherein said 3D image display system uses an optical principle characterized in the “localizing the shuttering process in the limited visual space”, wherein the optical shielding and penetrating process due to shutter switching is confined on the screen of the display such that the optical process is not performed upon the ambient light outside the screen, so as to cooperate with conventional displays such as a television, a monitor, a liquid crystal monitor, a plasma display panel, and a projector to effectively reduce the flickering phenomenon.

2. The 3D image display system as claimed in claim 1, wherein said liquid crystal polarizer placed on said pair of electronic liquid crystal polarizing spectacles comprises:
two pieces of transparent conductive glass for enclosing and protecting the liquid crystal molecule layer and receiving an external electric signal;
a liquid crystal molecule layer for performing the optical function upon said polarized image according to said driving signal, wherein the polarized orientation of said polarized image is rotated by 90° when said liquid crystal molecule layer is not applied with any external voltage signal while the polarized orientation of said polarized image remains when said liquid crystal molecule layer is applied with an external voltage signal; and
a linear polarizer through which said polarized image is filtered out or penetrating.

3. The 3D image display system as claimed in claim 1, wherein said image polarizing processor is a linear polarizing filter.

4. The 3D image display system as claimed in claim 1, wherein said image filter and said image synchronizer are placed in the spectacle frame of said pair of electronic liquid crystal polarizing spectacles.
